(19) United States
(12) Patent Application Publication
(10) Pub. No.: US 2022/0090856 A1
(43) Pub. Date: Mar. 24, 2022

(54) APPARATUS FOR THE SEPARATION OF AIR BY CRYOGENIC DISTILLATION COMPRISING THREE COLUMNS, INCLUDING TWO CONCENTRIC COLUMNS

(71) Applicant: L'Air Liquide, Societe Anonyme pour l'Etude et l?Exploitation des Procedes Georges Claude, Paris (FR)

(72) Inventor: Patrick LE BOT, Jouy-En-Josas (FR)

(73) Assignee: L'Air Liquide, Societe Anonyme pour l'Etude et l?Exploitation des Procedes Georges Claude, Paris (FR)

(21) Appl. No.: 17/481,055

(22) Filed: Sep. 21, 2021

(30) Foreign Application Priority Data
Sep. 21, 2020 (FR) FR 2 009 535

(51) Int. Cl. F25J 3/04

(52) U.S. Cl. CPC F25J 3/0443

(57) ABSTRACT

An apparatus for the separation of air by cryogenic distillation comprises three columns, including two concentric columns, the external diameter of the third column being at most equal to that of the second distillation column, a pipe for feeding the third column with air, a reflux pipe connected to an intermediate level of the upper section of the first distillation column in order to withdraw a liquid enriched in nitrogen, the pipe being connected to the head of the second distillation column and passing through a region of the third column devoid of heat exchange means and of mass exchange means, and an intermediate pipe for withdrawing a liquid at an intermediate level of the first distillation column.

### CROSS REFERENCE TO RELATED APPLICATIONS

This application claims the benefit of priority under 35 U.S.C. § 119 (a) and (h) to French patent application No. FR2009535, filed Sep. 21, 2020, the entire contents of which are incorporated herein by reference.

### FIELD OF THE INVENTION

The present invention relates to an apparatus for the separation of air by cryogenic distillation comprising at least three separation columns, including two concentric columns.

### BACKGROUND OF THE INVENTION

It is known to separate air in a double distillation column comprising a first column operating at a first pressure and a second column operating at a second pressure lower than the first pressure. Conventionally, the tank of the second column is thermally connected to the head of the first column.

A third column can be connected to the second column and optionally to the first column.

This third column can be of Etienne column type, operating at a pressure between the first and second pressures and fed by a liquid enriched in oxygen originating from the tank of the first column. A fluid enriched in oxygen and a fluid enriched in nitrogen, which are produced in the third column, can feed the second column at different levels.

This third column can be of mixing column type, being fed at the head by an oxygen-rich liquid originating from the second column and at the tank by a gas poorer in oxygen, such as air.

In this case, the third column directly produces an oxygen-rich gas withdrawn at the head of the third column.

While the first and the second column form a structure called a double column, the third column is independent of this structure.

In a regular configuration, the second column is superimposed on the first column and has a diameter greater than that of the first column. The section of the cold box, which has to contain the two columns, is thus dictated by the diameter of the second column. To add an additional column, such as a third column described above, further increases the cross-section of the cold box, indeed even requires the addition of a supplementary box. Other architectures than this architecture are known, such as those described in EP 1 078 212 B1, but nevertheless require a widening of the cold box or another box.

It is thus advantageous to benefit from the space available under the second large-diameter column in order to house the additional column therein. Advantageously, it will be concentric with the first column.

As the space available (and thus the thickness of this concentric column) is limited, this configuration is particularly suitable for adding a column which treats a gaseous charge (which proportions to the first order the passage section of the column) which is low in comparison with the air flow feeding the system composed of the first and of the second column. This is the case for the third column of Etienne column type, which treats approximately 40 mol % of the total flow of feed air at an intermediate pressure, or of mixing column type, which treats approximately 30 mol % of the total flow of feed air, for example at the first pressure.

The choice of the packing of this concentric column (and of the first and second columns) can be judiciously adjusted in order for its capacity to be such that it is not necessary to have an exterior diameter of the concentric column which is greater than that of the second column.

DE3709566 discloses a double column positioned inside another double column, thus forming four distillation compartments, the two double columns having a common tank.

Research Disclosure “Air Separation Low Purity Oxygen Production” proposes to position the mixing column inside the high-pressure column, thus the contrary of what is proposed in the present invention. It is suggested to use concentric columns but, given the basic premise, it is the high-pressure column that would be the annular column.

FR 2 776 206 describes concentric columns but with segments that operate in series. Thus, the distillation that is carried out in the interior column of FIG. 1 is the continuation of that begun in the annular column, which surrounds it.

### SUMMARY OF THE INVENTION

According to certain embodiments of the present invention, there is provided an apparatus for the separation of air by cryogenic distillation comprising a system of columns, including a first distillation column capable of operating at a first pressure having an upper section and a lower section, a second distillation column capable of operating at a second pressure lower than the first pressure and having a diameter and a third separating column, for example distillation column, of annular section, having an internal diameter and an external diameter, which is positioned around the first column, the external diameter of the third column being at most equal to that of the second column, the apparatus also comprising a pipe for sending air to the first column, a pipe for sending a fluid enriched in oxygen to an intermediate point of the second column, a pipe for feeding the third column with air or with at least one fluid originating from the first, a reflux pipe connected to an intermediate level of the upper section of the first column in order to withdraw a liquid enriched in nitrogen, the pipe being connected to the head of the second column and passing through a region of the third column devoid of mass exchange means, and a pipe for withdrawing a liquid from the first column, the pipe being connected to another column of the system of columns and passing through a region of the third column devoid of mass transfer means, wherein the second distillation column does not contain any other distillation column.

According to other optional aspects:
the head of the third column is connected in order to receive bottom liquid from the second column;
no pipe is connected in order to send air to the third column;
the apparatus comprises a pipe for exiting an oxygen-rich gas at the head or at an intermediate point of the third column;
the third column is connected in order to receive bottom liquid from the first column;
the second column is connected in order to receive head liquid from the third column;
the apparatus does not comprise a space between the exterior wall of the upper section of the first column and the interior wall of the third column;
the exterior wall of the first column is the interior wall of the third column;
the apparatus is designed in order to operate with a difference in pressure between that of the third column and that of the first column of less than 3.5 bars, preferably of less than 2 bars;
the tank of the third column is positioned below the tank of the first column;
the first column is entirely contained inside the third column;
the apparatus comprises a thermally insulated chamber containing the first, second and third columns;
the second column has a greater diameter than that of the first column;
the second column does not contain a partition;
the first column has a closed tank;
the third column has a closed tank;
the second column and the third column have a common shell;
the first column is shorter than the third column;
the first column and the third column have a common roof; and/or
the roof of the first column forms at least a part of the tank of the second column.

According to another aspect of the invention, there is provided a process for the separation of air by cryogenic distillation in a system of columns, including a first distillation column capable of operating at a first pressure having an upper section and a lower section, a second distillation column capable of operating at a second pressure lower than the first pressure and having a diameter and a third separating column, for example distillation column, of annular section, having an internal diameter and an external diameter, which is positioned in annular fashion around the first column, the external diameter of the third column being at most equal to that of the second column, in which air is sent to the first column, a fluid enriched in oxygen is sent to an intermediate point of the second column, the third column is fed with air or with at least one fluid originating from the first, a liquid enriched in nitrogen is withdrawn through a reflux pipe connected to an intermediate level of the upper section of the first column, the reflux pipe being connected to the head of the second column and passing through a region of the third column devoid of heat exchange means and mass exchange means, and a liquid enriched in oxygen is withdrawn from the first column via a pipe connected to another column of the system of columns and passing through a region of the third column devoid of mass exchange means, characterized in that the second distillation column does not contain any other distillation column.

Preferably, the system comprises only the first distillation column capable of operating at a first pressure having an upper section and a lower section, the second distillation column capable of operating at a second pressure lower than the first pressure and having a diameter and the third separating column.

Preferably, all the space inside the second column operates at just one pressure. It is obvious that there will be minor differences in pressure between the top and the bottom of the column. On the other hand, at a given elevation of the second column, any mass and heat exchange means operates at the same pressure across the section of the column at this elevation.

Preferably, at any elevation of the second column, any mass and heat exchange means operates at the same pressure across the section of the column at this elevation.

If the third column is fed with air, the air flow feeding the third column can be between 20% and 40% (molar basis) of the total feed flow of the first, second and third columns.

The second column is not necessarily fed with air.

If the third column is fed with liquid enriched in oxygen originating from the first column, the flow feeding the third column can be between 30% and 50% (molar basis) of the total air feed flow of the first, second and third columns.

The second and the third columns are not necessarily fed with air.

According to certain embodiments of the invention, the third column is an annular column positioned around the upper part of the first column.

Preferably, the operating pressure of the annular column differs by less than 3.5 bars from the operating pressure of the first column.

Preferably, the operating temperature of annular column (third column) differs by less than 5° C. from the operating temperature of the first column.

Thus, the temperature differential is sufficiently small to prevent a transfer of heat between the first and third columns sufficiently significant to disrupt the distillation carried out in each of the columns.

In certain embodiments, if the temperatures of the columns are too different, it can be necessary to provide a thermal insulation system, such as, for example, a gas gap. The third column may include an exterior cylindrical wall and an interior cylindrical wall. The gas gap can be constituted by an annular space in the space surrounded by the interior wall and in contact with this interior wall. Devoid of mass and heat exchange means, the space is open at the bottom and/or at the top in order to isolate the third column from the first column but does not make possible short-circuiting of the gas to be distilled.

Preferably, at least one gas or liquid withdrawing is carried out from the part of the first column surrounded by the third column. This withdrawing, connected to the first column, passes through the third column, preferably in a zone devoid of mass and heat exchange means. The configuration of the packed sections of the third column K3 is preferably set up so that any (liquid or gas) withdrawal from the first column takes place in a zone devoid of packing of the third column.

### BRIEF DESCRIPTION OF THE DRAWINGS

Further features and advantages of the invention will become apparent from the description hereinafter of embodiments, which are given by way of illustration but without any limitation, the description being given in relation with the following attached figures:

FIG. 1 diagrammatically represents a three-column apparatus, the third column operating at a pressure intermediate between those of the other two columns.

FIG. 2 diagrammatically represents a three-column apparatus, the third column being a mixing column.

### DETAILED DESCRIPTION OF THE INVENTION

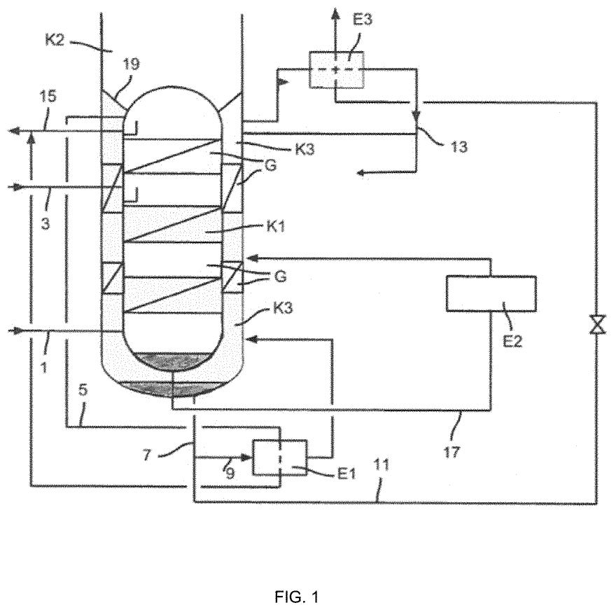

FIG. 1 illustrates an apparatus for the separation of air by cryogenic distillation comprising a first column K1 capable of operating at a first pressure having an upper section and a lower section and a second column K2 capable of operating at a second pressure lower than the first pressure and having a diameter.

The second column K2 is positioned above the first column K1, forming a single structure.

An air flow 1 is sent as feed gas into the tank of the first column K1, where it is separated by distillation into a liquid enriched in oxygen in the tank and a gas enriched in nitrogen at the head.

The first column K1 is also fed by a two-phase air flow 3 which, in the figure, passes in a pipe through the packings.

A passage outside the packings would be preferred.

A third column K3 of annular form, have a internal diameter and an external diameter, is positioned around the first column Kl; in the case illustrated, the third column is higher than the first column, so that the tank of the third column K3 is found below the tank of the first column K1.

The operating pressure of the annular column K3 differs by less than 3.5 bars from the operating pressure of the first column K1. The first column can, for example, operate at 6 bars and the third K3 at a pressure of between 3.5 and 4 bars.

The first column K1 comprises three sections of packings, one above the other, separated from one another by free spaces; the third column K3 has two of them. Obviously, the number of sections can vary as a function of the separations to be carried out. The sections of the column K1 have a circular base and those of the column K3 have an annular base.

In this case, the exterior wall of the first column K1 constitutes the interior wall of the third column K3. It is also possible for the first column to have an exterior wall and the third column a separate interior wall, with a space between the two walls. This space would be open over one of the ends in order to make possible optionally the establishment of an insulating gas gap.

The second column K2 has the same diameter as the external diameter of the third column K3. In this way, the columns K2, K3 can have a shell of the same diameter, indeed even a common shell. The top of the third column K3 is separated from the tank of the column K2 by a frustoconical barrier 19 which prevents the passage of any fluid.

Gaseous nitrogen formed at the head of the first column is withdrawn via a pipe passing through a space above the packagings of the third column K3. The nitrogen 5 is sent to a heat exchanger E1, where it is condensed to form a liquid.

Liquid nitrogen 15 is withdrawn via a pipe passing through a space above the packagings of the third column K3. It is mixed with the condensed nitrogen 5 originating from the exchanger E1.

Liquid enriched in oxygen 17 is withdrawn from the tank of the first column K1 through the third column K3 in a space devoid of packings. The liquid 17 is optionally supercooled in a heat exchanger E2 and sent to feed the third column K3, where it is separated.

The gas enriched in nitrogen formed at the head of the column K3 is withdrawn from the column and condensed in the heat exchanger E3 before being sent in part to the head of the column K3 as reflux and for another part to the head of the second column as reflux.

The bottom liquid 7 enriched in oxygen from the third column K3 is divided into two. A part 9 is vaporized in the heat exchanger E1 and feeds the tank of the third column K3. The remainder 11 is reduced in pressure in a valve to a pressure close to that of the second column and sent as cold source into the exchanger E3, where it is predominantly vaporized. The vaporized fraction and optionally a remaining liquid fraction are send as feed of the second column.

The second column K2, which is not illustrated in detail, corresponds to a normal low-pressure column of a double column.

Thus, the fraction(s) of the vaporized liquid 11 which feed(s) the second column is/are separated to form nitrogen at the head of the second column K2 and an oxygen-rich liquid in the tank of the second column K2.

The second column K2 is connected in order to receive head liquid 15 from the third column K3.

The apparatus can thus produce gaseous and/or liquid oxygen from the second column K2 and liquid and/or gaseous nitrogen from the first column.

The third column K3 corresponds to an Etienne column well known in the art.

The flow 17 feeding the third column K3 can be between 30% and 50% (molar basis) of the total air feed flow of the first, second and third columns (flows 1 and 3).

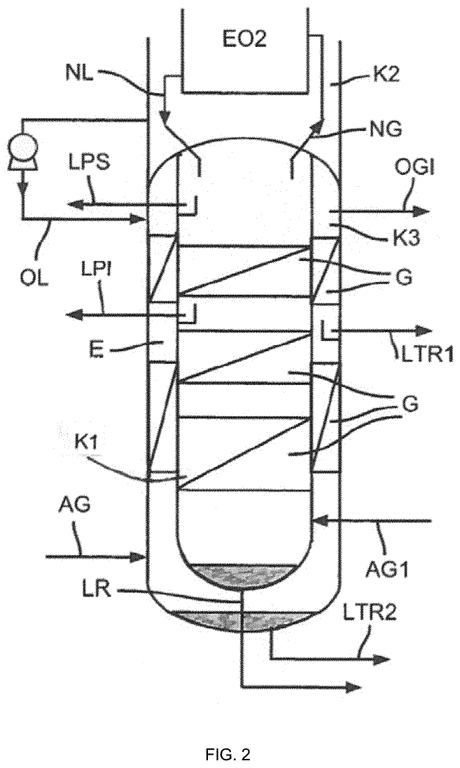

FIG. 2 illustrates an apparatus for the separation of air by cryogenic distillation comprising a first column K1 capable of operating at a first pressure having an upper section and a lower section and a second column K2 capable of operating at a second pressure lower than the first pressure and having a diameter.

The second column K2 is positioned above the first column K1, forming a single structure.

The first column K1 comprises two sections of packings, one above the other, separated by a space; the third column K3 has two sections of packings G. Obviously, the number of sections can vary as a function of the separations to be carried out. The sections of the third column K3 have an annular base.

In this case, the exterior wall of the first column K1 constitutes the interior wall of the third column K3. It is also possible for the first column to have an exterior wall and the third column a separate interior wall, with a space between the two walls. This space would be open over one of the ends in order to make possible optionally the establishment of an insulating gas gap. The second column K2 preferentially has the same diameter as the external diameter of the third column K3. In this way, the columns K2, K3 can have a common shell. The top of the third column K3 and the top of the first column K1 are separated from the tank of the column K2 by a barrier of circular section having the same diameter as the second column 2 and preventing the passage of any fluid apart from the nitrogen intended for and originating from an exchanger E02.

A gas air flow AG1 is sent as feed gas into the tank of the first column K1, where it is separated by distillation into a liquid enriched in oxygen in the tank and a gas enriched in nitrogen at the head.

A flow enriched in oxygen LR is withdrawn from the tank of the first column K1 and sent to the second column K2 in order to be separated therein. The head gas NG from the first column K1 is condensed in the heat exchanger E02 in the tank of the second column K2. The condensed liquid is returned at the head of the first column as reflux. Liquid nitrogen LPS is withdrawn from the head of the first column in a pipe passing through a packing-free space of the third column and is sent to the head of the second column K2 in a known way.

Liquid nitrogen LPI is withdrawn from an intermediate point of the first column K1 in a pipe passing through a preferentially packing-free space of the third column K3 and is sent to the top of the second column K2 in a known way.

The third column K3 operates as a mixing column, providing mixing between an oxygen-rich liquid sent to the head of the column and air AG sent to the tank of the column.

The product of the third column K3 is an oxygen-rich gas OGI withdrawn at the head of the column.

A liquid very rich in oxygen LTR1 is withdrawn at an intermediate point of the third column K3 and a second liquid very rich in oxygen LTR2 is withdrawn at the tank of the third column K3.

These two liquids LTR1, LTR2 are sent to the second column K2.

The air flow AG feeding the third column K3 can be between 20% and 40% (molar basis) of the total feed flow (AG1+AG) of the first and third columns.

The pressure of the third column K3 can be greater than, equal to or less than that of the first column K1. The presence of the pump of the flow OL withdrawn at the tank of the second column K2 makes it possible to obtain the desired pressure.

However, if the pressure of the column K3 differs from that of the first column by less than 3.5 bars, the presence of a gas gap will not be necessary. Thus, the pressure of the first column K1 can be 6 bars and that of the third column between 3 and 9 bars.

In both cases, the third column may surround only a part of the first column, for example the upper part or the lower part.

Preferably, in both cases, the second column has a diameter greater than that of the first column and/or equal to or greater than the exterior diameter of the third column.

The greatest diameter of a column is regarded as its diameter. For example, if the second column comprises an upper section, often referred to as a minaret, having a smaller diameter than the main part of the column, it is the diameter of the main part which is regarded as the diameter.

For both figures, the packings of the first column K1 are structured packings. For both figures, the packings of the third column K3 are random packings. Preferably, the pressure of the third column differs from that of the first column by at least 1 bar.

For the case of FIG. 2, the pressures of the first and third columns can be equal.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

I claim:

1. An apparatus for the separation of air by cryogenic distillation comprising:
a system of columns, including a first distillation column configured to operate at a first pressure having an upper section and a lower section,
a second distillation column configured to operate at a second pressure lower than the first pressure and having a diameter;
a third separating column having an annular cross-section and having an internal diameter and an external diameter, the third separating column being positioned around the first distillation column, the external diameter of the third separating column being at most equal to that of the second distillation column;
a first pipe configured to send air to the first distillation column;
a second pipe configured to send a fluid enriched in oxygen to an intermediate point of the second distillation column;
a third pipe configured to feed the third separating column with air or with at least one fluid originating from the first distillation column;
a reflux pipe connected to an intermediate level of the upper section of the first distillation column in order to withdraw a liquid enriched in nitrogen, the reflux pipe being connected to the head of the second distillation column and passing through a region of the third separating column devoid of mass exchange means; and
a fourth pipe configured to withdraw a liquid from the first distillation column, the fourth pipe being connected to another column of the system of columns and passing through a region of the third separating column devoid of mass transfer means,
wherein the second distillation column does not contain any other distillation column.

2. The apparatus according to claim 1, wherein the head of the third separating column is connected in order to receive bottom liquid from the second distillation column.

3. The apparatus according to claim 2, further comprising a fifth pipe configured to withdraw an oxygen-rich gas at the head or at an intermediate point of the third separating column.

4. The apparatus according to claim 1, wherein the third separating column is connected in order to receive bottom liquid from the first distillation column.

5. The apparatus according to claim 1, wherein the second distillation column is connected in order to receive head liquid from the third separating column.

6. The apparatus according to claim 1, further comprising an absence of a space between the exterior wall of the upper section of the first distillation column and the interior wall of the third separating column.

7. The apparatus according to claim 6, wherein the exterior wall of the first distillation column is the interior wall of the third separating column.

8. The apparatus according to claim 1, wherein the apparatus is configured to operate with a difference in pressure between that of the third separating column and that of the first distillation column of less than 3.5 bars.

9. The apparatus according to claim 1, wherein the tank of the third separating column is positioned below the tank of the first distillation column.

10. The apparatus according to claim 1, wherein the first distillation column is entirely disposed inside the third separating column.

11. The apparatus according to claim 1, further comprising a thermally insulated chamber containing the first distillation column, the second distillation column, and the third separating column.

12. A process for the separation of air by cryogenic distillation in a system of columns, the method comprising the steps of:
providing the system of columns, wherein the system of columns comprises
a first distillation column configured to operate at a first pressure having an upper section and a lower section,
a second distillation column configured to operate at a second pressure lower than the first pressure and having a diameter;
a third separating column having an annular cross-section and having an internal diameter and an external diameter, the third separating column being positioned around the first distillation column, the external diameter of the third separating column being at most equal to that of the second distillation column;
sending air to the first distillation column,
introducing a fluid enriched in oxygen to an intermediate point of the second distillation column,
feeding air or at least one fluid originating from the first distillation column to the third separating column,
withdrawing a liquid enriched in nitrogen through a reflux pipe connected to an intermediate level of the upper section of the first distillation column, the reflux pipe being connected to the head of the second distillation column and passing through a region of the third separating column devoid of mass exchange means, and
withdrawing a liquid enriched in oxygen from the first distillation column via a pipe connected to another column of the system of columns and passing through a region of the third separating column devoid of mass exchange means,
wherein the second distillation column comprises an absence of any other distillation column.

13. The process according to claim 12, wherein the third separating column is fed with air, wherein the air flow feeding the third separating column is between 20% and 40% (molar basis) of the total feed flow of the first distillation column, the second distillation column, and the third separating column.

14. The process according to claim 12, wherein the third separating column is fed with liquid enriched in oxygen originating from the first distillation column, wherein the flow feeding the third separating column is between 30% and 50% (molar basis) of the total air feed flow of the first distillation column, the second distillation column, and the third separating column.

15. The process according to claim 12, wherein, at a given elevation of the second distillation column, any mass and heat exchange means operates at the same pressure across the cross-section of the second distillation column at this elevation.

16. The process according to claim 15, wherein, at any elevation of the second distillation column, any mass and heat exchange means operates at the same pressure across the cross-section of the second distillation column at this elevation.
